(19) United States
(12) Patent Application Publication
(10) Pub. No.: US 2009/0300734 A1
(43) Pub. Date: Dec. 3, 2009

(54) AUTHENTICATION SYSTEM, AUTHENTICATION METHOD AND COMPUTER-READABLE STORAGE MEDIUM STORING AUTHENTICATION PROGRAM

(75) Inventor: Hirotsugu Hiramoto, Kobe-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/408,014

(22) Filed: Mar. 20, 2009

(30) Foreign Application Priority Data
Jun. 3, 2008 (JP) 2008-145523

(51) Int. Cl. G06F 17/00

(52) U.S. Cl. 726/5

(57) ABSTRACT

An authentication system including an apparatus, in the system use of the apparatus is restricted by an authentication processing according to authentication information, the system having: decision section to compare inputted authentication information with pre-stored authentication information and to notify a message indicating that the authentication information has been changed in a case where the inputted authentication information is not the same as the updated authentication information but is the same as the previously set authentication information.

### RELATED APPLICATION

This application is based on Japanese Patent Application No. 2008-145523 filed on Jun. 3, 2008 in Japan Patent Office, the entire content of which is hereby incorporated by reference.

### BACKGROUND

1. Field of the Invention

The present invention relates to an authentication system, authentication method and computer-readable storage medium storing authentication program, particularly to an authentication system including the apparatus employed by a plurality of users such as an image forming apparatus, an authentication method and a computer-readable storage medium storing authentication program for this system.

2. Description of Related Art

There has been a widespread use in the use of a processing apparatus provided with a copying function, printing function and scanning function (hereinafter referred to as “image forming apparatus”). This image forming apparatus may store a document containing confidential information, and requires sophisticated security measures to be taken to prevent possible leakage of confidential information. Thus, authentication information such as a password is set in advance. When an image forming apparatus is to be used, a user is required to input authentication information, and only the user having been authenticated is allowed to utilize the image forming apparatus.

In this case, if the same authentication information is used for a long time, authentication information may leak out and the security may not be ensured. This requires the authentication information to be appropriately renewed or updated by the user. In this case, the user having changed the authentication information is permitted to use the image forming apparatus by inputting updated authentication information. Other users without being notified of the change in authentication information input old authentication information and are not permitted to use the image forming apparatus. To solve this problem, a method has been proposed to grant authentication in the case of old authentication information as well under predetermined conditions.

For example, the Japanese Unexamined Patent Publication No. 5-30103 (Tokkaihei) discloses a method wherein, when a terminal is linked with the line of a monitoring center, data communication is allowed only where there is agreement between one of the two-generation new/old passwords having been sent from the monitoring center, and the self-contained password.

Further, the Japanese Unexamined Patent Publication No. 2000-82044 (Tokkai) discloses another method wherein a request from the authenticated user to change the password is accepted, and in response to the processing of updating the password, a new password is set and the old password is retained. In response to the request for authentication from that user next time, the old password is scrapped if requested by new password, whereas limited or restricted authentication is provided if requested by old password.

However, if use of the apparatus is permitted when any one of the new and old authentication information has been inputted, as disclosed in the Japanese Unexamined Patent Publication No. 5-30103 (Tokkaihei) and Japanese Unexamined Patent Publication No. 2000-82044 (Tokkai), two types of authentication information will be accepted. In this case, once authentication information has been acquired through an illegal route, the countermeasure of updating the authentication information will be meaningless.

In the meantime, when a plurality of users share the authentication information and one of the users have updated the authentication information, other users are not allowed to use the apparatus, as described above. These users will waste a lot of time to find out a proper step, because they have to check and input authentication information several times and to search for the information on the change of authentication information.

In view of the prior art problems described above, it is a major object of one aspect of the present invention to provide an authentication system, authentication method and a computer-readable storage medium storing authentication program wherein updating of authentication information is adequately handled without security being endangered.

### SUMMARY

To achieve at least one of the abovementioned objects and other objects, an authentication system reflecting first aspect of the present invention comprises: an apparatus, use of the apparatus is restricted by an authentication processing according to authentication information in the system; and decision section to compare inputted authentication information with pre-stored authentication information and to notify a message indicating that the authentication information has been changed in a case where the inputted authentication information is not the same as the updated authentication information but is the same as the previously set authentication information.

According to another aspect of the present invention, the authentication information for notifying the message can be selected from the previously set authentication information and the decision section notifies the message in a case where the selected information is input.

According to still another aspect of the present invention, the message includes information that specifies a user having updated the authentication information.

According to yet another aspect of the present invention, the message includes information that specifies the date and time when the updated authentication information has been created.

According to other aspect of the present invention, the message includes information that specifies a method for acquiring the updated authentication information.

### BRIEF DESCRIPTION OF THE DRAWINGS

FIG. 1 is a diagram schematically showing the structure of the authentication system in an example of the present invention;

FIG. 2 is a block showing the structure of the component related to authentication of the image forming apparatus in an example of the present invention;

FIG. 3 is a diagram showing an example of the screen (password input screen) displayed on the display section of the image forming apparatus (or computer terminal) in an example of the present invention;

FIG. 4 is a diagram showing an example of the screen (password updating screen) displayed on the display section of the image forming apparatus (or computer terminal) in an example of the present invention;

FIG. 5 is a diagram showing an example of the screen (error notification change screen) displayed on the display section of the image forming apparatus (or computer terminal) in an example of the present invention;

FIG. 6 is a flow chart representing the specific procedure of the authentication method of an authentication system (in the case of the image forming apparatus alone) in an example of the present invention; and

FIG. 7 is a flow chart representing the specific procedure of the authentication method of an authentication system (in the case of the image forming apparatus and computer terminal) in an example of the present invention.

### DESCRIPTION OF PREFERRED EMBODIMENTS

As described with reference to the Background, authentication information such as a password is utilized in a system including the apparatus used by a plurality of users. To ensure security, authentication information is updated whenever required. In this case, if an attempt is made to accept both the new and old authentication information, such an effort for updating of the authentication information will be wasted. In the meantime, if means are provided not to accept any old authentication information at all, other users are obliged to spend a lot of time to get the updated authentication information, with the result that user convenience is much reduced.

To solve such problems, when old authentication information has been inputted, the present embodiment notifies a message showing that the authentication information has been updated, without accepting the old authentication information on an unconditional basis or rejecting any of the old authentication information. This procedure clearly indicates that the authentication information has been updated and ensures the processing time to be reduced.

In this case, the message notifies the information that specifies the user who has updated the authentication information. This allows other users to identify the person that should be checked for the updated authentication information, and to reduce the time of these users. Thus, the new authentication information is checked with a user of management level authorized to update the authentication information. This arrangement prevents authentication information from being obtained through an illegal route.

If the message to be sent includes the information that specified the date and time of the authentication information having been updated, and the method for acquiring the updated authentication information, other users will be correctly informed of how to verify the updated authentication information. This arrangement reduces the time of processing.

Further, if selection can be made in such a way that, when a particular information item of the previously set authentication information has been inputted, the message should be sent, it is possible to exclude the users who know only the several-generation old authentication information, with the result that the security level can be enhanced. Further, if means are taken to select the apparatus to which the message should be sent, the message can be sent to the computer terminal of the user having inputted the authentication information, with the result that the security level can be enhanced. Further, if means are provided to select the method for sending the message, the user convenience is improved.

### EXAMPLES

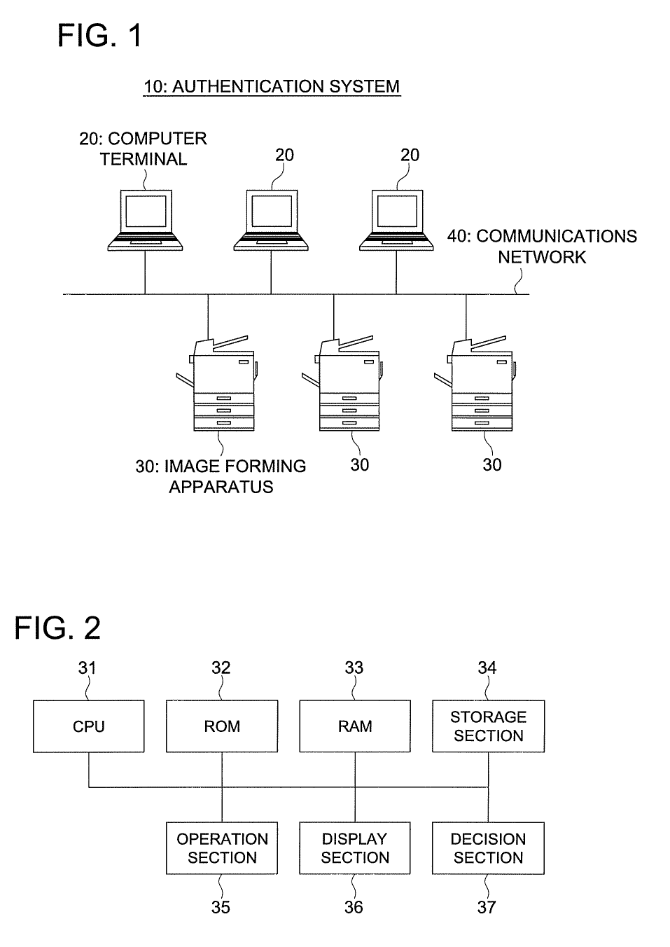

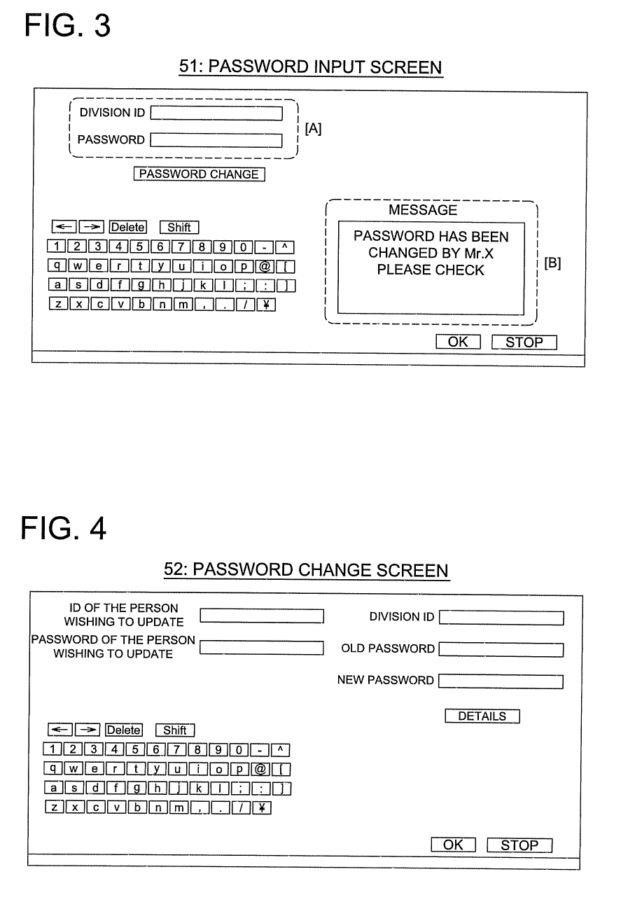

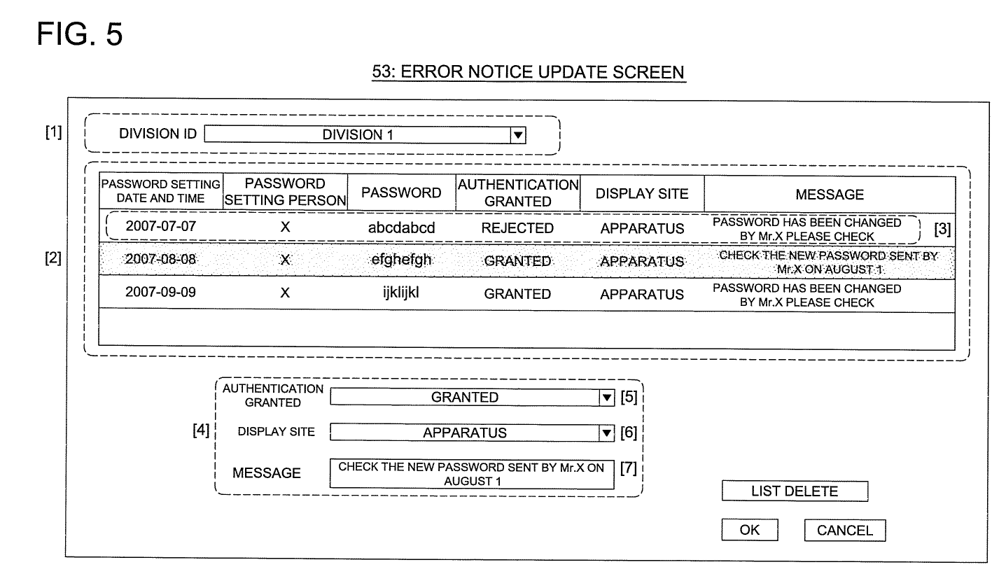

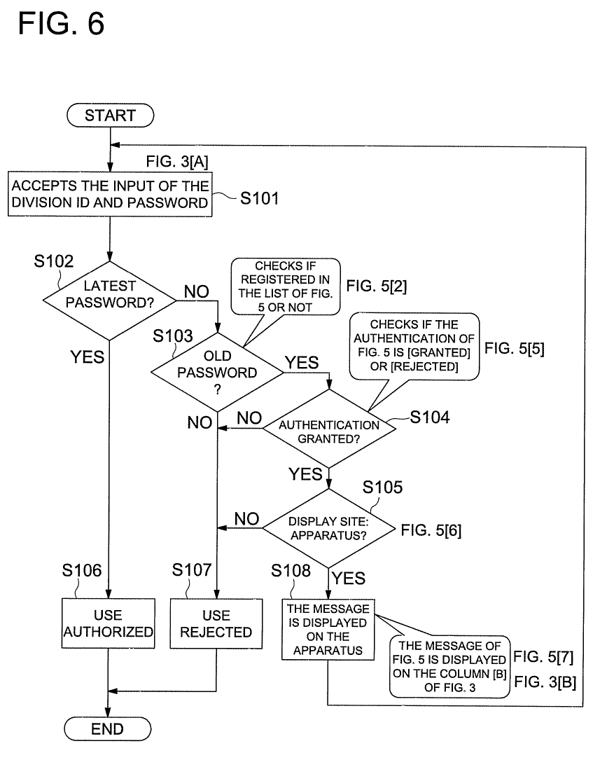

For the purpose of more detailed explanation of the embodiments of the present invention, the following describes the authentication system, authentication method and authentication program as an example of the present invention, with reference to FIGS. 1 through 7. FIG. 1 is a diagram schematically showing the structure of the authentication system in an example of the present invention. FIG. 2 is a block diagram showing the structure of the component related to authentication of the image forming apparatus in an example of the present invention. FIGS. 3 through 5 are the diagrams showing an example of the structure of the screen displayed on the display section of the authentication system. FIGS. 6 and 7 are the flow chart representing the procedure of the authentication method in this example.

As shown in FIG. 1, the authentication system 10 of this example includes a computer terminal 20 of one or more clients who input printing instructions, and one or more image forming apparatuses 30 such as network printers or multi-functional peripherals for executing the printing instruction. These components are interconnected with each other via the communications network 40 such as LAN (Local Area Network) or WAN (Wide Area Network).

In FIG. 1, the authentication system 10 includes the computer terminal 20 and image forming apparatus 30. However, the authentication system 10 can be made up of the image forming apparatus 30 alone. In this case, both the input of authentication information, and the message notification regarding the fact that authentication information has been updated can be carried out by the image forming apparatus 30. Further, the apparatus for authentication can be a processing apparatus that performs any desired processing, without being restricted to the image forming apparatus 30. Further, a management server or others can be used for authentication in this example.

FIG. 2 is a block diagram showing the structure of the component related to authentication of this example, out of the structure of the image forming apparatus 30. This component includes the CPU (Central Processing Unit) 31, ROM (Read Only Memory) 32, RAM (Random Access Memory) 33, storage section 34, operation section 35, display section 36, decision section 37 and others.

The CPU 31 serves as a control section that allows the control program stored in the ROM 22 to be developed on the RAM 33 and executed, and that controls various operations of the image forming apparatus 30.

The storage section 34 is a nonvolatile medium using an HDD (hard Disk Drive) and others, and serves to store the authentication information or the like. The authentication information includes the password that is most recently set (hereinafter referred to as “latest password”) and one or more previously set old passwords (hereinafter referred to as “old passwords”).

The operation section 35 includes a touch panel or the like, and is used to input an ID, password and message to be issued.

The display section 36 includes an LCD (Liquid Crystal Display) and others, and is used to display a password input screen, password update screen and error notice update screen that will be described later.

The decision section 37 make comparison between the password inputted from the operation section 35, and the password having been registered in advance in the storage section 34. If the password having been inputted is the latest password, the decision section 37 authorizes use of the image forming apparatus 30. If the password having been inputted is not the latest password, the decision section 37 determines if that password is the old password or not. If it is the old password, the decision section 37 allows the display section 36 to display the message notifying that the password has been updated. If the password having been inputted is not the latest password or old password, the decision section 37 gives a message to show that the password is incorrect, whereby use of the image forming apparatus 30 is rejected.

The aforementioned decision section 27 can be incorporated as hardware in the image forming apparatus 30, or can be formed as an authentication program that allows the computer to serve as a decision section 27. This authentication program can be designed to operate on the apparatus constituting the authentication system 10 such as the image forming apparatus 30.

In this example, authentication information is stored in the storage section 34 of the image forming apparatus 30. It is only required that the authentication information should be stored in a desired apparatus (capable of referencing the decision section 37) of the authentication system 10.

In this example, a password is used for authentication. The key stroke pattern (information on the time interval of the key being pressed) can be also used for authentication. Alternatively, the biometric information of fingerprints or veins, and the order of inputting the print of each finger can also be employed for authentication. Further, an IC card, magnetic card or RFID (Radio Frequency Identification) tag containing the ID and password stored therein in advance can be also utilized for authentication.

Referring to the screens of FIGS. 3 through 5, the following describes the method of authentication in the authentication system 10 of the present example.

FIG. 3 shows an example of the password input screen 51 displayed on the display section 36 of the image forming apparatus 30 (or the display section of the computer terminal 20). The password input screen 51 is formed of the column for inputting a division ID and password (Column “A” in the drawing), the column for inputting a message (Column “B”), and a software keyboard serving as an operation section 35.

By correctly inputting the division ID and password, the user of the image forming apparatus 30 is allowed to use the image forming apparatus 30. In the case of the previously set old password instead of the latest password, a message indicating that the password has been changed is shown in the message column. When the password is to be updated, the password update screen 52 of FIG. 4 pops up by pressing the [Password Update] button.

FIG. 4 shows an example of the password update screen 52. The password update screen 52 is made of the column for inputting the ID and password of the user wishing to update the password; the column for inputting the division ID, the password prior to updating (old password) and password subsequent to updating (latest password); and a software keyboard serving as the operation section 35.

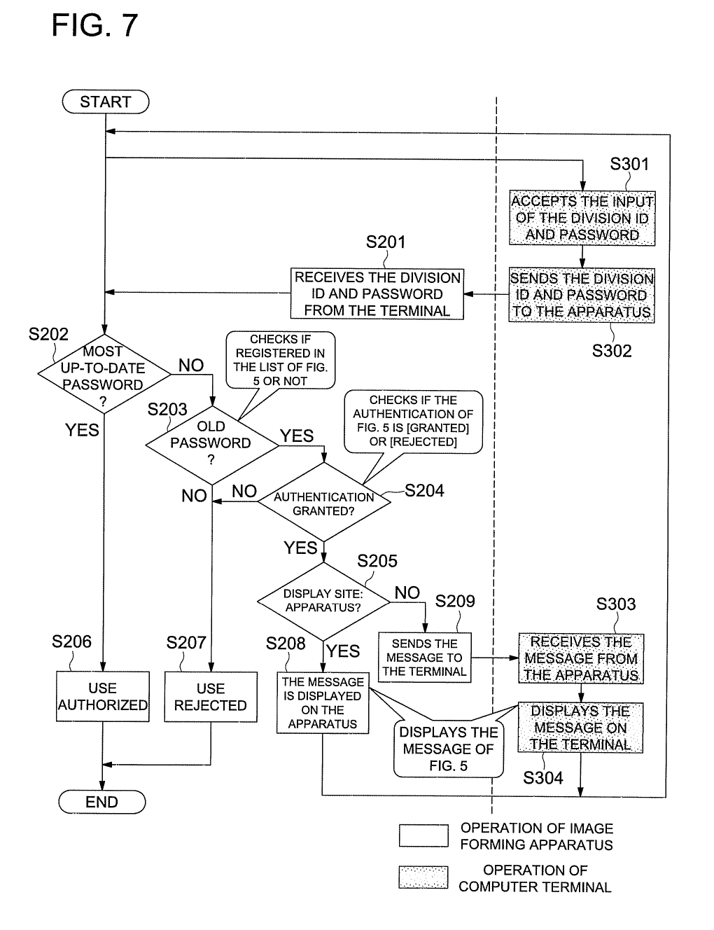

The user wishing to update the password is required to input the [ID of the person wishing to update] and [password of the person wishing to update] that have been registered in advance. Then the user inputs the [division ID], [old password] and [new password], and presses the [OK] button. This procedure completes updating of the password. Further, the error notice update screen 53 of FIG. 5 pops up by pressing the [Details] button.

FIG. 5 shows an example of the error notice update screen 53. The error notice update screen 53 is made of the column for inputting the division ID (column [1] of the drawing), the column for displaying the details setting information on password (column [2]), and the column for correcting the details setting information on password having been selected (column [4]).

In the first place, the [division ID] of [1] is selected from the pulldown menu. Then the list having been set and updated is displayed (See [2]). For an administrator, the list of all the persons having set is preferably displayed for the benefit of list administration. When the password has been updated, the [Authentication granted]: [Rejected], [Display site]: [Apparatus], [Message]: [The password has been updated by XXX (name of the person). Please check the password with him.], for example, are automatically registered in the list (See [3]) as default values.

To update the setting, the cursor is placed on the list wherein setting is to be updated. Then the [Authentication granted], [Display site] and [Message] currently displayed on the column [4] appear. The setting information on the second line (hatched portion) of the drawing appears.

When the [Authentication granted] is to be updated, the [Granted] or [Rejected] is selected from the pull-down menu (See [5]). In the example of FIG. 5, the [Granted] is set, and the [Display site] and [Message] are displayed. When the [Rejected] has been set, the image forming apparatus 30 cannot be used with this password as before. The message is not issued.

When the [Display site] is to be updated, the [Apparatus] or [Terminal] is selected from the pull-down menu in the similar manner (See [6]). When the [Apparatus] has been selected, the message is displayed on the image forming apparatus 30. When the [Terminal] has been selected, the message is displayed on the computer terminal 20.

The [Message] can be edited by text edition (See [7]). For example, in [7], the method for acquiring the latest password is notified, as exemplified by the method of checking the mail sent from the user having created the latest password. This message can be set as desired, so long as it is the information that serves to give tips on the method of acquiring the latest password. It can be the information that specifies the user having created the latest password, as shown in [3], the information that specifies the date and time when the latest password is created, or the information consisting of a desired combination of these information items.

The relevant information together with the list can be deleted by pressing the [List Delete].

The structure in the above description is designed in such a way that the [Authentication granted], [Display site] and [Message] are set for each message. However, the present invention is not restricted to these setting items. Further, in the above description, the message is displayed on the screen. The method of sending the message can also be set. For example, the message can be issued in the form of a voice from the speaker installed on the image forming apparatus 30 or computer terminal 20 in advance.

As described above, when the password is inputted using the password input screen 51, the message indicating that the password has been updated is issued, if the password having been inputted is an old password instead of the latest password. This arrangement allows the user to get the latest password by referencing that message. Further, it is also possible to use the error notice update screen 53 to set the procedure to be taken when the old password has been inputted, the message display site and message contents. This arrangement ensures adequate control to be performed despite the frequency of updating the password.

Refer to the flow charts of FIGS. 6 and 7, the following describes the specific procedure of the authentication method in the authentication system 10 of the present example. Authentication of the present example is executed in two cases—only by the image forming apparatus 30, and by the computer terminal 20 and image forming apparatus 30. The following describes each case.

[When Authentication is Executed Only by the Image Forming Apparatus 30]

Authentication procedure in this case is illustrated in the flow chart of FIG. 6. In this case, the latest password and old password are assumed to have been registered in the storage section 34 of the image forming apparatus 30 in advance.

In the first place, in the Step S101, the control section of the image forming apparatus 30 allows the display section 36 to display the password input screen 51 of FIG. 3. The inputs of the division ID and password are accepted in the column [A].

In Step S102, the decision section 37 checks to see whether or not the inputted password agrees with the latest password registered in the storage section 34 in advance.

If agreement is found out, use of the image forming apparatus 30 is authorized in Step S106. If agreement is not found out, the decision section 37 checks in Step S103 to see whether or not the inputted password agrees with the old password registered in the storage section 34.

If agreement with the old password is not found out, use of the image forming apparatus 30 is rejected in Step S107. If there is agreement with the old password, the decision section 37 checks in Step S104 to see if authentication for that old password (information given in [5] of FIG. 5) is [Granted] or [Rejected].

When set to the [Rejected], use of the image forming apparatus 30 is rejected in Step S107. If set to the [Granted], the decision section 37 checks in Step S105 to see if the display site for that old password (information displayed in [6] of FIG. 5) is the [Apparatus] or [Terminal].

If the display site is the [Terminal], use of the image forming apparatus 30 is rejected in Step S107. If the display site is the [Apparatus], the message for that old password (information given in [7] of FIG. 5) is displayed on the column B of the password input screen 51 of FIG. 3.

[When Authentication is Executed by the Image Forming Apparatus 30 and Computer Terminal 20]

The authentication procedure in this case is illustrated in the flow chart of FIG. 7. The hatched step in the drawing indicates the step of processing performed by the computer terminal 20. In this case, the latest password and old password are assumed to have been registered in the storage section 34 of the image forming apparatus 30 in advance.

In Step S301, the control section of the computer terminal 20 allows the display section to display the password input screen 51 of FIG. 3. The inputs of the division ID and password are accepted by column [A] and the division ID and password having been inputted into the image forming apparatus 30 is sent in Step S302.

In the image forming apparatus 30, the division ID and password from the computer terminal 20 is received in Step S201.

In Step S202, the decision section 37 checks to see whether or not the password received from the computer terminal 20 agrees with the latest password registered in the storage section 34 in advance.

If agreement between passwords is found out, use of the image forming apparatus 30 is authorized in Step S206. If agreement between passwords is not found out, the decision section 37 checks in Step S203 to see whether or not there is agreement between the received password and the old password registered in the storage section 34.

When there is no agreement between the received password and the old password, use of the image forming apparatus 30 is rejected in Step S207. When there is agreement between the received password and the old password, the decision section 37 checks in Step S204 to see if the authentication for that old password (information given in [5] of FIG. 5) is [Granted] or [Rejected].

When set to [Rejected], use of the image forming apparatus 30 is rejected in Step S207. When set to [Granted], the decision section 37 checks in Step S205 to see if the display site for that old password (information displayed in [6] of FIG. 5) is the [Apparatus] or [Terminal].

If the display site is the [Apparatus], the message for that old password (information given in [7] of FIG. 5) is displayed on the display section 36. In this case, any desired method can be used for display.

For example, the password input screen 51 of FIG. 3 can be displayed, and the message can be shown on the column [B] thereof.

If the display site is the [Terminal], the message for the old password is sent in Step S209 to the computer terminal 20 wherein the division ID and password have been sent. The computer terminal 20 receives the message from the image forming apparatus 30 in Step S303 and displays the received message on the display section in Step S304.

Thus, the user having inputted the old password is notified by the message that the password has been updated. After getting the latest password, the user again takes the step for using the apparatus. This procedure authorizes the user to employ the image forming apparatus 30, thereby ensuring appropriate handling of the updating of the password. Further, no message is shown for the user having inputted the password that is neither the latest password nor old password. This eliminates the possibility of illegal use (misappropriation) of the image forming apparatus 30 and ensures security.

In the aforementioned example, the authentication system 10 including the image forming apparatus 30 has been taken up for discussion. It should be noted, however, that the present invention is applicable to the system including any desired processing apparatus employed by a plurality of users, without being restricted to the aforementioned example.

The present invention is applicable to the system including such a processing apparatus as an image forming apparatus used by a plurality of users, as well as to the authentication method and authentication program of such a system.

According to the embodiments of the present invention, updating of authentication information is adequately handled without security being endangered.

This is because the authentication system is provided with a decision section, which compares the inputted authentication information with the previously stored authentication information. If the inputted authentication information is updated authentication information, the decision section authorizes use of an apparatus. If it is not the updated authentication information, the decision section checks whether or not the inputted information is the previously set authentication information. If the inputted information is the previously set authentication information, the decision section issues a message showing that the authentication information has been updated, and gives tips on how to acquire the updated authentication information. If the inputted information is not the previously set authentication information, the decision section provides control to reject the use of the apparatus.

What is claimed is:

1. An authentication system including an apparatus, wherein in the system use of the apparatus is restricted by an authentication processing according to authentication information, the system comprising:
a decision section to compare inputted authentication information with pre-stored authentication information and to notify a message indicating that the authentication information has been changed in a case where the inputted authentication information is not the same as the updated authentication information but is the same as the previously set authentication information.

2. The authentication system of claim 1, wherein authentication information for notifying the message can be selected from the previously set authentication information and the decision section notifies the message in a case where the selected information is input.

3. The authentication system of claim 1, wherein the message includes information that specifies a user having updated the authentication information.

4. The authentication system of claim 1, wherein the message includes information that specifies the date and time when the updated authentication information has been created.

5. The authentication system of claim 1, wherein the message includes information that specifies a method for acquiring the updated authentication information.

6. A method of authentication utilizing authentication information, comprising:
registering updated authentication information and previously set authentication information;
allowing input of authentication information; and
comparing the inputted authentication information with the registered authentication information and notifying a message which indicates that the authentication information has been changed in a case where the inputted authentication information is not the same as the updated authentication information but is the same as the previously set authentication information.

7. The authentication method of claim 6, wherein the registering step comprises selecting authentication information for notifying the message from the previously set authentication information and the notifying step comprises notifying the message in a case where the selected authentication information has been inputted.

8. The authentication method of claim 6, wherein the message includes information that specifies a user having updated authentication information.

9. The authentication method of claim 6, wherein the message includes information that specifies the date and time when the updated authentication information has been created.

10. The authentication method of claim 6, wherein the message includes information that specifies a method for acquiring the updated authentication information.

11. A computer-readable storage medium storing computer program executable by a computer to make the computer function as a decision section in a system including an apparatus, wherein use of the apparatus is restricted by an authentication processing according to authentication information, wherein the decision section performs:
comparing inputted authentication information with pre-stored authentication information; and
notifying a message indicating that the authentication information has been changed in a case where the inputted authentication information is not the same as the updated authentication information but is the same as the previously set authentication information.

12. The computer-readable storage medium of claim 11, wherein the authentication information for notifying the message can be selected from the previously set authentication information and the decision section notifies the message in a case where the selected information is input.

13. The computer-readable storage medium of claim 11, wherein the message includes information that specifies a user having updated the authentication information.

14. The computer-readable storage medium of claim 11, wherein the message includes information that specifies the date and time when the updated authentication information has been created.

15. The computer-readable storage medium of claim 11, wherein the message includes information that specifies a method for acquiring the updated authentication information.
